(19) United States
(12) Patent Application Publication
(10) Pub. No.: US 2025/0264349 A1
(43) Pub. Date: Aug. 21, 2025

(54) FLOWMETER PRIMARY CONTAINMENT FAILURE DETECTION

(71) Applicant: MICRO MOTION, INC., Boulder, CO (US)

(72) Inventors: Martijn BOOGAARTS, Duiven (NL); Jason Alan LEAPLEY, Firestone, CO (US); Marc Allan BUTTLER, Erie, CO (US)

(73) Assignee: MICRO MOTION, INC., Boulder, CO (US)

(21) Appl. No.: 18/845,280

(22) PCT Filed: Mar. 28, 2022
(86) PCT No.: PCT/US2022/022105

§ 371 Date: Sep. 9, 2024

(51) Int. Cl. G01F 1/84; G01F 15/14; G01L 1/22

(52) U.S. Cl. CPC G01F 1/8431; G01F 1/8422; G01F 1/8427; G01F 1/8477; G01F 15/14; G01L 1/2262

(57) ABSTRACT

A flowmeter is provided that includes a sensor assembly and meter electronics configured to detect a containment failure within a flowmeter case. One or more flow tubes and a drive mechanism are coupled to the one or more flow tubes and oriented to induce a drive mode therein. A pair of pickoff sensors is coupled to the flow tubes and configured to measure a vibrational response induced by the drive mechanism. At least one strain gage is inside the case, and configured to detect strain. The meter electronics is connected to the drive mechanism and the at least one strain gage, and are connected in series. The meter electronics is configured to measure a resistance of the strain gage, and compare the resistance to a baseline resistance. A primary containment failure is indicated if the resistance of the strain gage is different from the baseline resistance by a predetermined amount.

### FIELD OF THE INVENTION

The embodiments described below relate to vibrating meters, and more particularly, to improved vibrating flowmeters utilizing strain gage-mediated primary containment detection.

### BACKGROUND

Vibrating conduit sensors, such as Coriolis mass flowmeters and vibrating densitometers, typically operate by detecting motion of a vibrating conduit that contains a flowing material. Properties associated with the material in the conduit, such as mass flow, density and the like, can be determined by processing measurement signals received from motion transducers associated with the conduit. The vibration modes of the vibrating material-filled system generally are affected by the combined mass, stiffness, and damping characteristics of the conduit and the material contained therein.

It is well known to use vibrating flowmeters to measure mass flow and other properties of materials flowing through a pipeline. For example, vibrating Coriolis flowmeters are disclosed in U.S. Pat. No. 4,491,025 issued to J. E. Smith, et al. of Jan. 1, 1985 and also U.S. Pat. No. Re. 31,450 to J. E. Smith of Nov. 29, 1983. These flowmeters have one or more fluid tubes. Each fluid tube configuration in a Coriolis mass flowmeter has a set of natural vibration modes, which may be of a simple bending, torsional, radial, lateral, or coupled type. Each fluid tube is driven to oscillate at resonance in one of these natural modes. The vibration modes are generally affected by the combined mass, stiffness, and damping characteristics of the containing fluid tube and the material contained therein, thus mass, stiffness, and damping are typically determined during an initial calibration of the flowmeter using well-known techniques. A common design vibrates two flow tubes in a single mode shape that can be described as the out-of-phase bending mode for those tubes. This mode is often referred to as the “drive” mode because it is the vibration mode that the drive coil of the meter intentionally excites.

Material flows into the flowmeter from a connected pipeline on the inlet side of the flowmeter. The material is then directed through the fluid tube or fluid tubes and exits the flowmeter to a pipeline connected on the outlet side.

A driver, such as a voice-coil style driver, applies a force to the one or more fluid tubes. The force causes the one or more fluid tubes to oscillate. When there is no material flowing through the flowmeter, all points along a fluid tube oscillate with an identical phase. As a material begins to flow through the fluid tubes, Coriolis accelerations cause each point along the fluid tubes to have a different phase with respect to other points along the fluid tubes. The phase on the inlet side of the fluid tube lags the driver, while the phase on the outlet side leads the driver. Sensors are placed at two different points on the fluid tube to produce sinusoidal signals representative of the motion of the fluid tube at the two points. A phase difference of the two signals received from the sensors is calculated in units of time.

The phase difference between the two sensor signals is proportional to the mass flow rate of the material flowing through the fluid tube or fluid tubes. The mass flow rate of the material is determined by multiplying the phase difference by a flow calibration factor. The flow calibration factor is dependent upon material properties and cross sectional properties of the fluid tube. One of the major characteristics of the fluid tube that affects the flow calibration factor is the fluid tube's stiffness. Prior to installation of the flowmeter into a pipeline, the flow calibration factor is determined by a calibration process. In the calibration process, a fluid is passed through the fluid tube at a given flow rate and the proportion between the phase difference and the flow rate is calculated. The fluid tube's stiffness and damping characteristics are also determined during the calibration process as is generally known in the art.

One advantage of a Coriolis flowmeter is that the accuracy of the measured mass flow rate is largely not affected by wear of moving components in the flowmeter, as there are no moving components in the vibrating fluid tube. The flow rate is determined by multiplying the phase difference between two points on the fluid tube and the flow calibration factor. The only input is the sinusoidal signals from the sensors indicating the oscillation of two points on the fluid tube. The phase difference is calculated from the sinusoidal signals. Since the flow calibration factor is proportional to the material and cross sectional properties of the fluid tube, the phase difference measurement and the flow calibration factor are not affected by wear of moving components in the flowmeter.

A typical Coriolis mass flowmeter includes one or more transducers (or pickoff sensors), which are typically employed in order to measure a vibrational response of the flow conduit or conduits, and are typically located at positions upstream and downstream of the driver. The pickoff sensors are connected to electronic instrumentation. The instrumentation receives signals from the two pickoff sensors and processes the signals in order to derive a mass flow rate measurement, among other things.

Leaking flow conduits and manifolds are a potential point of failure in flowmeter systems. Automatically detecting such a leak would be desirable for troubleshooting systems that are not performing to specification. It may not, however, be immediately apparent that a leak has occurred when the leak is internal to the flowmeter case.

A leakage detection system can be of great benefit for critical applications. A direct alert to the system allows fast response that prevents further harm to the environment, the installation site, and/or the process itself.

Historically, such systems utilize a pressure transmitter inside the flowmeter case to detect such issues. There are a number of drawbacks to such a system. Installation is generally complex. Case temperature fluctuations may cause detectable pressure fluctuations that would falsely cause the sensor to report a leak. Regulatory approvals are more costly and time-consuming with such a system installed. Integration into standard flowmeter transmitters and their ability to power the pressure transmitter while also reading Coriolis signals is logistically difficult and generally cost prohibitive.

The embodiments described below overcome these and other problems and an advance in the art is achieved. The embodiments described below provide a flowmeter that employs a strain gage to detect primary containment failure. Existing wiring is utilized so installation is simple, reliable, and less costly than alternative approaches.

### SUMMARY OF THE INVENTION

A flowmeter including a sensor assembly and a meter electronics configured to detect a containment failure within a flowmeter case is provided according to an embodiment. The flowmeter comprises one or more flow tubes, and a drive mechanism coupled to the one or more flow tubes and oriented to induce a drive mode vibration in the one or more flow tubes. A pair of pickoff sensors is coupled to the one or more flow tubes, and configured to measure a vibrational response of the flow tubes induced by the drive mechanism. At least one strain gage is inside the case configured to detect a strain. The meter electronics is connected to the drive mechanism and the at least one strain gage, and the drive mechanism and the at least one strain gage are connected in series. The meter electronics is configured to measure a resistance of the strain gage, and compare the resistance of the strain gage to a baseline resistance, and wherein the meter electronics is configured to indicate the primary containment failure if the resistance of the strain gage is different from the baseline resistance by a predetermined amount.

A method for detecting a containment failure within a case of a flowmeter having a sensor assembly and meter electronics is provided according to an embodiment. The method comprises vibrating at least one of the one or more flow tubes in a drive mode vibration with a drive mechanism, and measuring a vibrational response of the flow tubes induced by the drive mechanism with a pair of pickoff sensors. At least one strain gage is provided inside the case. The drive mechanism and the at least one strain gage are connected to the meter electronics, wherein the drive mechanism and the at least one strain gage are connected in series. A resistance of the strain gage is measured and compared to a baseline resistance. Containment failure is indicated if the resistance of the strain gage is different from the baseline resistance by a predetermined amount.

### ASPECTS

According to an aspect, a flowmeter includes a sensor assembly and a meter electronics configured to detect a containment failure within a flowmeter case. The flowmeter comprises one or more flow tubes, and a drive mechanism coupled to the one or more flow tubes and oriented to induce a drive mode vibration in the one or more flow tubes. A pair of pickoff sensors is coupled to the one or more flow tubes, and configured to measure a vibrational response of the flow tubes induced by the drive mechanism. At least one strain gage is inside the case configured to detect a strain. The meter electronics is connected to the drive mechanism and the at least one strain gage, and the drive mechanism and the at least one strain gage are connected in series. The meter electronics is configured to measure a resistance of the strain gage, and compare the resistance of the strain gage to a baseline resistance, and wherein the meter electronics is configured to indicate the primary containment failure if the resistance of the strain gage is different from the baseline resistance by a predetermined amount.

Preferably, meter electronics is configured to trigger an alarm if the resistance of the strain gage is different from the baseline resistance by a predetermined amount.

Preferably, the at least one strain gage is coupled to a flowmeter case.

Preferably, the at least one strain gage is coupled to the one or more flow tubes. Preferably, the at least one strain gage is coupled to a brace bar.

Preferably, a signal from the one or more strain gages is superimposed onto other signals carried by a drive mechanism series circuit.

Preferably, a drive mechanism series circuit comprises a Wheatstone bridge.

According to an aspect, a method for detecting a containment failure within a case of a flowmeter having a sensor assembly and meter electronics is provided. The method comprises vibrating at least one of the one or more flow tubes in a drive mode vibration with a drive mechanism, and measuring a vibrational response of the flow tubes induced by the drive mechanism with a pair of pickoff sensors. At least one strain gage is provided inside the case. The drive mechanism and the at least one strain gage are connected to the meter electronics, wherein the drive mechanism and the at least one strain gage are connected in series. A resistance of the strain gage is measured and compared to a baseline resistance. Containment failure is indicated if the resistance of the strain gage is different from the baseline resistance by a predetermined amount.

Preferably, the method comprises the step of triggering an alarm if the resistance of the strain gage is different from the baseline resistance by a predetermined amount.

Preferably, the method comprises the step of coupling the at least one strain gage to the flowmeter case.

Preferably, the method comprises the step of coupling the at least one strain gage to the one or more flow tubes.

Preferably, the method comprises the step of coupling the at least one strain gage to a brace bar.

Preferably, the method comprises the step of superimposing a signal from the one or more strain gages onto other signals carried by a drive mechanism series circuit.

Preferably, the method comprises the step of providing a Wheatstone bridge in a drive mechanism series circuit.

### BRIEF DESCRIPTION OF THE DRAWINGS

The same reference number represents the same element on all drawings. The drawings are not necessarily to scale.

FIG. 1 illustrates a prior art flowmeter;

FIG. 2 illustrates an embodiment of a flowmeter;

FIG. 3 illustrates an embodiment of a flowmeter;

FIG. 4 illustrates an embodiment of a flowmeter;

FIG. 5 illustrates an embodiment of a flowmeter; and

FIG. 6 is a diagram of meter electronics.

### DETAILED DESCRIPTION OF THE INVENTION

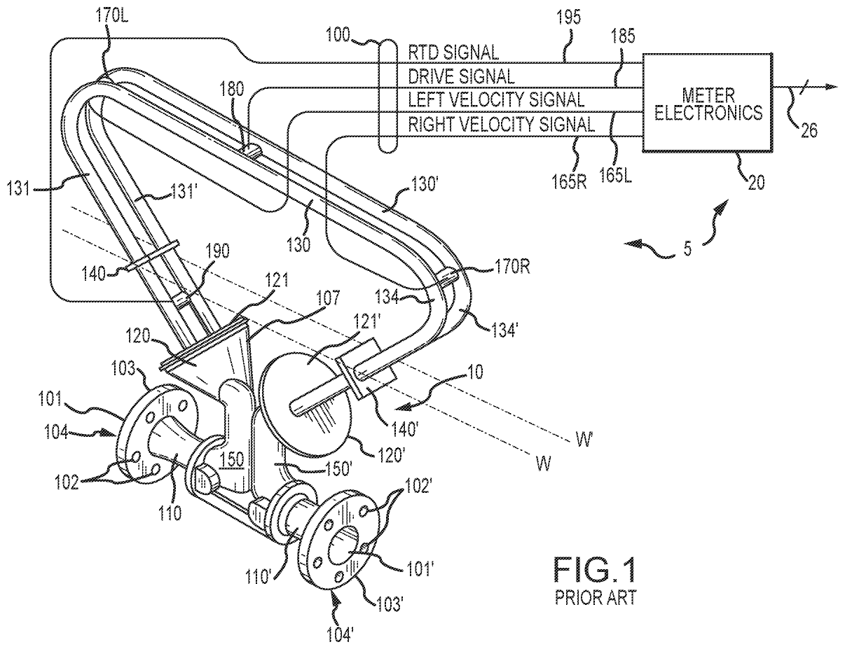

FIGS. 1-6 and the following description depict specific examples to teach those skilled in the art how to make and use the best mode of embodiments of a flowmeter and related methods. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a prior art flowmeter 5, which can be any vibrating meter, such as a Coriolis flowmeter. The flowmeter 5 comprises a sensor assembly 10 and meter electronics 20. The sensor assembly 10 responds to mass flow rate and density of a process material. Meter electronics 20 are connected to the sensor assembly 10 via leads 100 to provide density, mass flow rate, and temperature information over path 26, as well as other information not relevant to the present invention. Sensor assembly 10 includes a pair of manifolds 150 and 150′, flanges 103 and 103′ having flange necks 110 and 110′, a pair of parallel flow tubes 130 (first flow tube) and 130′ (second flow tube), driver mechanism 180, temperature sensor 190 such as a resistive temperature detector (RTD), and a pair of pickoffs 170L and 170R, such as magnet/coil pickoffs, strain gages, optical sensors, or any other pickoff sensor known in the art. The flow tubes 130 and 130′ each have inlet legs 131 and 131′ and outlet legs 134 and 134′, which converge towards flow tube mounting blocks 120 and 120′. Flow tubes 130 and 130′ bend at least one symmetrical location along their length and are essentially parallel throughout their length. Brace bars 140 and 140′ serve to define the axis W and W′ about which each flow tube oscillates.

The side legs 131, 131′ and 134, 134′ of flow tubes 130 and 130′ are fixedly attached to flow tube mounting blocks 120 and 120′ and these blocks, in turn, are fixedly attached to manifolds 150 and 150′. This provides a continuous closed material path through the sensor assembly 10.

When flanges 103 and 103′, having holes 102 and 102′ are connected, via inlet end 104 and outlet end 104′ into a process line (not shown) which carries the process material that is being measured, material enters end 104 of the meter through an orifice 101 in flange 103 and is conducted through manifold 150 to flow tube mounting block 120 having a surface 121. Within manifold 150 the material is divided and routed through flow tubes 130 and 130′. Upon exiting flow tubes 130 and 130′, the process material is recombined in a single stream within manifold 150′ and is thereafter routed to exit end 104′ connected by flange 103′ having bolt holes 102′ to the process line (not shown).

Flow tubes 130 and 130′ are selected and appropriately mounted to the flow tube mounting blocks 120 and 120′ so as to have substantially the same mass distribution, moments of inertia, and Young's modulus about bending axes W-W and W′-W′, respectively. These bending axes go through brace bars 140 and 140′. Inasmuch as the Young's modulus of the flow tubes change with temperature, and this change affects the calculation of flow and density, temperature sensor 190 is mounted to flow tube 130′, to continuously measure the temperature of the flow tube. The temperature of the flow tube and hence the voltage appearing across the temperature sensor 190 for a given current passing therethrough is governed by the temperature of the material passing through the flow tube. The temperature-dependent voltage appearing across the temperature sensor 190 is used in a well-known method by meter electronics 20 to compensate for the change in elastic modulus of flow tubes 130 and 130′ due to any changes in flow tube temperature. The temperature sensor 190 is connected to meter electronics 20 by lead 195.

Both flow tubes 130 and 130′ are driven by driver 180 in opposite directions about their respective bending axes W and W′ at what is termed the first out-of-phase bending mode of the flowmeter. This driver 180 may comprise any one of many well-known arrangements, such as a magnet mounted to flow tube 130′ and an opposing coil mounted to flow tube 130, through which an alternating current is passed for vibrating both flow tubes. A suitable drive signal is applied by meter electronics 20, via lead 185, to the driver 180.

Meter electronics 20 receive the temperature signal on lead 195, and the left and right velocity signals appearing on leads 165L and 165R, respectively. Meter electronics 20 produce the drive signal appearing on lead 185 to driver 180 and vibrate tubes 130 and 130′. Meter electronics 20 process the left and right velocity signals and the temperature signal to compute the mass flow rate and the density of the material passing through sensor assembly 10. This information, along with other information, is applied by meter electronics 20 over path 26 to utilization means.

For clarity, the number of conductors shown has been minimized. Although only a single line is drawn for 26, 165L, 165R, 185, and 195, this single line may represent one or more conductors.

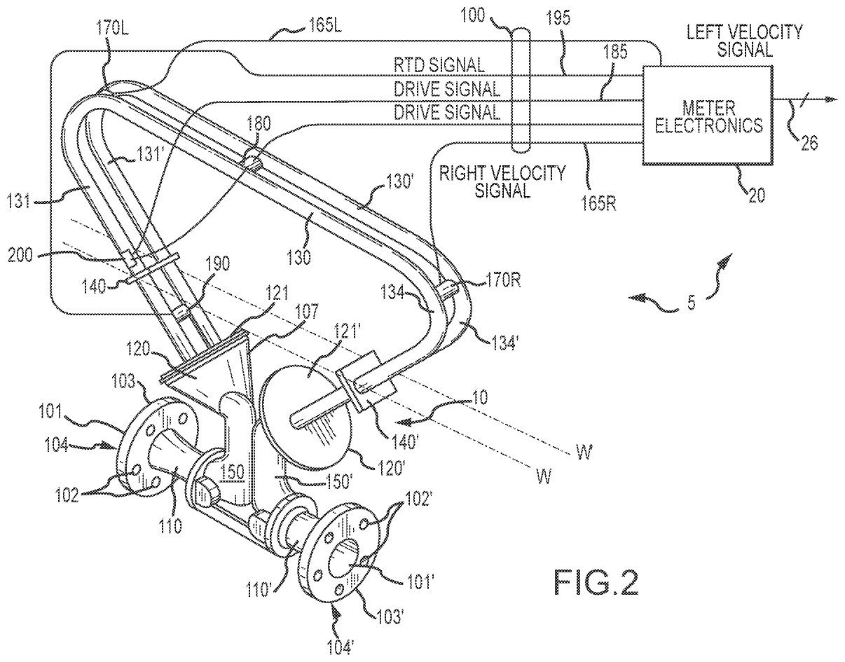

FIG. 2 illustrates an embodiment of a flowmeter 5. A Coriolis flowmeter structure is described although it is apparent to those skilled in the art that the present invention could be practiced as a vibrating tube densitometer without the additional measurement capability provided by a Coriolis mass flowmeter. Common elements with the prior art device of FIG. 1 share the same reference numbers. The flow tubes 130 and 130′ are driven by driver 180 in opposite directions about their respective bending axes W and W′ and at what is termed the first out-of-phase bending mode of the flowmeter. This driver 180 may comprise any one of many well-known arrangements, such as a magnet mounted to flow tube 130′ and an opposing coil mounted to flow tube 130 and through which an alternating current is passed for vibrating both flow tubes. It should be noted that the flow tubes 130, 130′ are substantially rigid—made from a metal, for example—such that they are capable of only limited motion, such as, for example, the vibratory motion induced by a driver. A suitable drive signal is applied by meter electronics 20, via lead 185, to the driver 180. A pair of pickoffs 170L and 170R, such as magnet/coil pickoffs, strain gages, optical sensors, or any other pickoff sensor known in the art is provided.

At least one strain gage 200 is provided. As illustrated, the strain gage 200 is located on inlet leg 131 of the first flow tube 130. The strain gage 200 is connected in series with the driver 180, with various segments of lead 185 illustrated for added clarity.

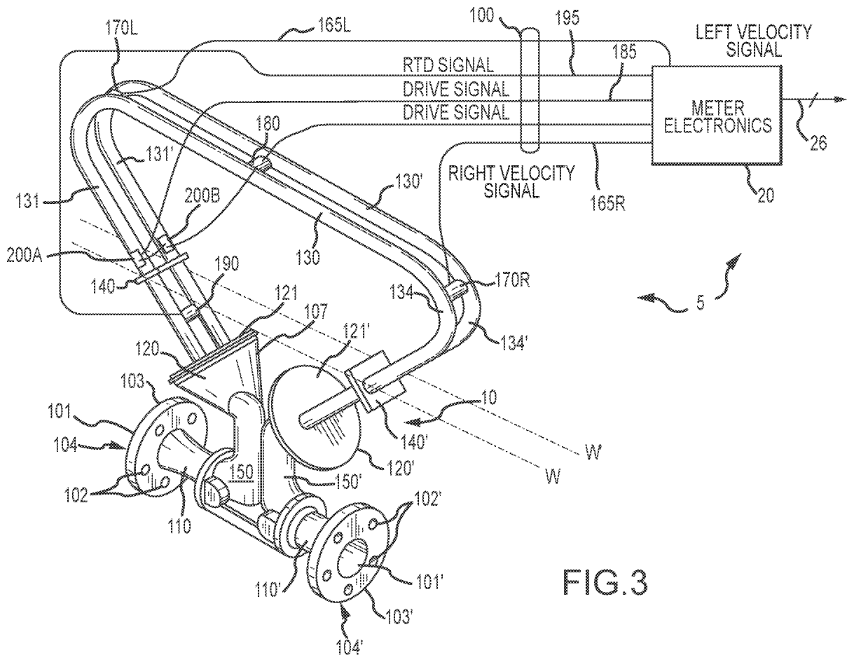

FIG. 3 illustrates a first strain gage 200A located on inlet leg 131 of the first flow tube 130 as well as an additional second strain gage 200B located on the inlet leg 131′ of the second flow tube 130′. Strain gages may be on both flow tubes 130, 130′ in embodiments. Strain gages may be on both outlet legs 134, 134′ in embodiments. Strain gages may be on any combination of at least one inlet leg 131, 131′ and at least one outlet leg 134, 134′ in embodiments.

FIGS. 2 and 3 illustrate the strain gages 200A, 200B on the inlet legs 131, 131′ of the flow tubes 130, 130′. It should be noted that the strain gages 200A, 200B may be placed on outlet legs 134, 134′, closer to the driver 180 than presently illustrated, on brace bars 140, 140′, transducer mounts, manifolds 150, 150′, flow tube mounting blocks 120, 120′, or any other portion of the sensor assembly 10. Overall, the strain element(s) are attached to the flow tube(s) and/or other part(s) of the meter structure that experience strain when a primary containment failure has occurred. The strain gages 200A, 200B are connected in series with the driver 180, with various segments of lead 185 illustrated for added clarity.

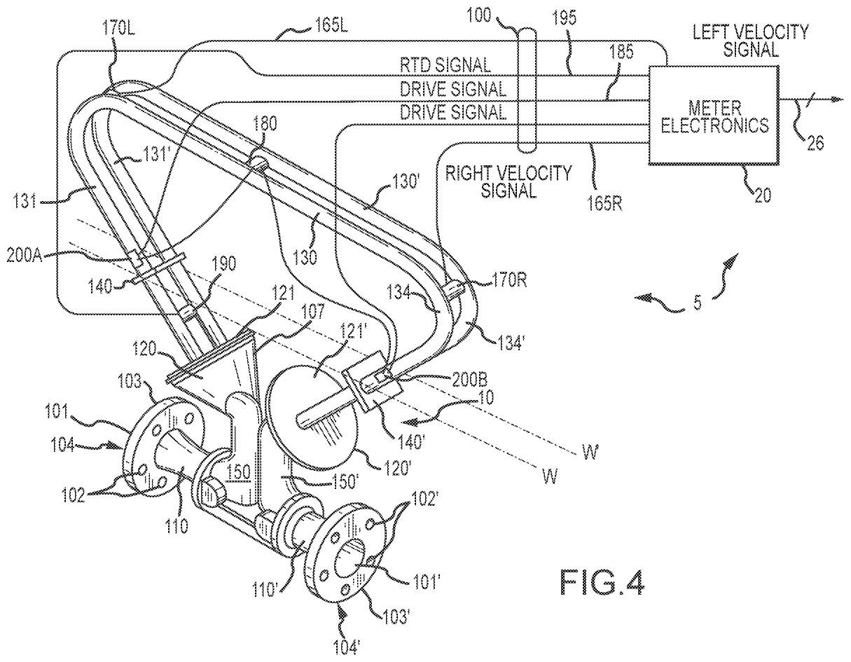

FIG. 4 illustrates a first strain gage 200A installed on the inlet leg 131 and a second strain gage 200B on the outlet leg 134 of the same flow conduit 131. The strain gages 200A, 200B are connected in series with the driver 180, with various segments of lead 185 illustrated for added clarity.

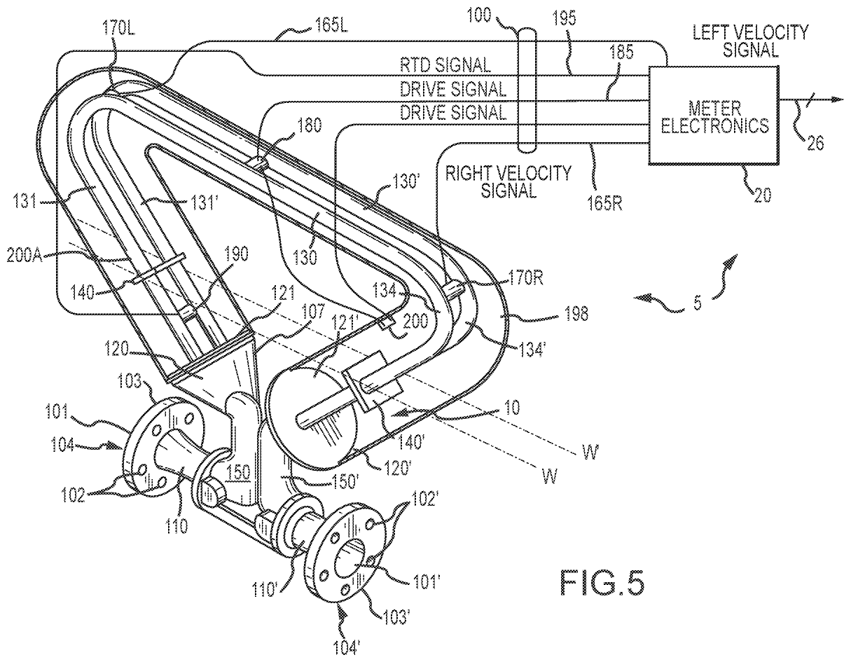

FIG. 5 illustrates a strain gage installed on a case portion 198 of the flowmeter 5. It should be noted that electrical connections between the driver 180 and strain gage 200 are schematically illustrated for clarity, and would generally be contained within the confines of the case 198. Only one strain gage 200 is illustrated, but multiple strain gages, as in FIGS. 3 and 4, may be attached to the case 198. In another embodiment, strain gages may be attached to both the case 198 and a flow conduit. The strain gage 200 is connected in series with the driver 180, with various segments of lead 185 illustrated for added clarity.

As illustrated, the strain gages 200A, 200B are connected in series in the driver 180 circuit. This confers the advantage of being able to deliver signal from these strain gage elements to the Coriolis transmitter without requiring any change to the number of conductors in an existing meter feedthrough design or the transmitter connection. The strain elements are connected in series with each other and also in series with the existing drive coil circuit. By using the drive coil circuit, the pickoff coil signals that are critical to the flow and density measurements made by the meter are left intact. In the illustrated series connection, the driver is disposed between the two strain gages 200A, 200B. It is contemplated that the driver be the first element in the circuit, with regard to current flow. It is also contemplated that the driver be the last element in the circuit, with regard to current flow. It is also contemplated that the driver be an element in between strain gages in the circuit, with regard to current flow.

In one embodiment, the signals from the one or more strain gages are transported superimposed onto other signals carried by existing driver circuit conductors. By transmitting the strain gage signals via signal conductors that already exist in earlier designs of extant flow meters, this embodiment can be implemented and retrofitted onto existing meter designs with greater ease.

This unique approach allows the indication to be made and used in a diagnostic within the meter transmitter, while eliminating the need for additional signal and/or power wires through the feedthrough to power a traditional pressure transmitter.

In an embodiment, an alarm and/or notification is generated when strain signals received by the meter electronics are indicative of a primary containment failure. The alarm and/or notification is triggered when a change in baseline resistance readings from the strain gage(s) is (are) different by a predetermined amount. As there are numerous strain gage configurations, differing number of strain gages, different strain gage installation locations, different flowmeter materials, configurations and sizes, the baseline resistance and threshold will vary from application to application, as will be understood by those skilled in the art.

In an embodiment, when strain signals received by the meter electronics are indicative of a primary containment failure, the meter electronics automatically halts operation of the flowmeter. The halting is triggered when a change in baseline resistance readings from the strain gage(s) is (are) different by a predetermined amount.

For clarity, the number of conductors shown has been minimized for FIGS. 2-5. Although only a single line is drawn for 26, 165L, 165R, and 195, this single line may represent one or more conductors. Conductor 185, however, is shown in greater schematic detail to clearly illustrate the series nature of the driver and strain gage circuit.

Changes in resistance of the strain gages 200A, 200B are caused by the strain in the underlying surfaces to which they are attached. The default strain gage resistance can be read and baselined into the transmitter at the factory. In the case of a primary containment failure and pressure increase inside the case, the strain gage measures a noticeable shift, which is indicated by a change in resistance. It is worth noting that the magnitude and/or sensitivity of the resistance shift is not important, but rather the binary indication that the resistance has changed from the baseline need all that be detected.

Wheatstone bridge circuits may be used for amplifying the signals. In an embodiment, strain signals from the internal vibrating structure of the flowmeter are input into the meter electronics and processed to detect changes in strain that may be indicative of an internal leak.

This unique approach allows containment failure indications to be made and used in a diagnostic within the meter transmitter, while eliminating the need for additional signal and/or power wires through the feedthrough to power a traditional pressure transmitter, thus allowing the use of existing wiring schemes.

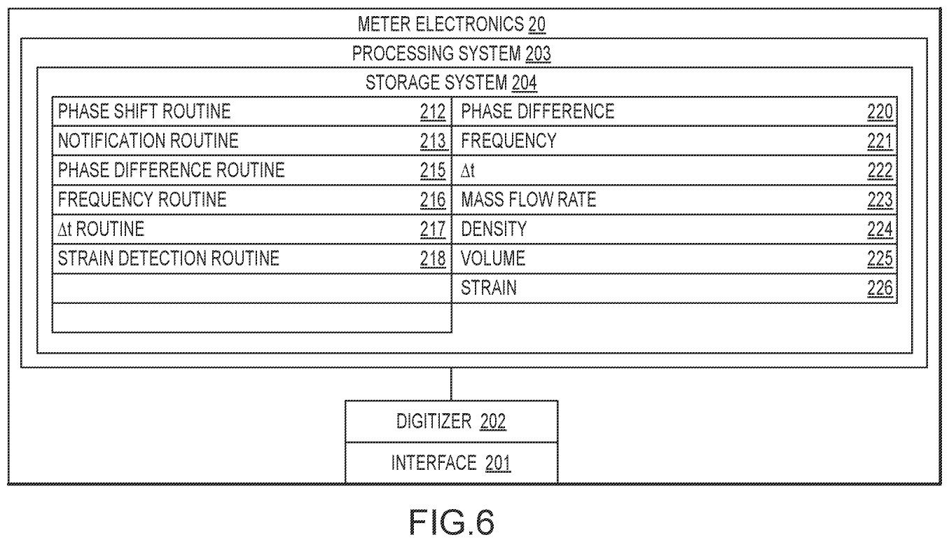

FIG. 6 illustrates meter electronics 20 of the flowmeter 5 according to an embodiment of the invention. The meter electronics 20 can include an interface 201 and a processing system 203.

The meter electronics 20 receives signals from the sensor assembly 10, such as strain gage signals, RTD signals, driver signal, and pickoff signals, for example, in order to obtain flow characteristics of the flow material flowing through the sensor assembly 10. For example, the meter electronics 20 can determine one or more of a phase difference, a frequency, a time difference (Δt), a density, a mass flow rate, a strain, and a volume flow rate from the sensor signals, for example. In addition, other flow characteristics can be determined according to the invention.

The interface 201 receives strain gage signals via the leads utilized for the drive signal. Any strain gages 200A, 200B and driver(s) 180 are connected in series. The interface 201 can perform any necessary or desired signal conditioning, such as any manner of formatting, amplification, buffering, etc. Alternatively, some or all of the signal conditioning can be performed in the processing system 203. The meter electronics may apply well-established digital signal processing (DSP) techniques to transform either the dynamic resistance measurement of the circuit and/or dynamic changes in the drive current into the frequency domain.

In addition, the interface 201 can enable communications between the meter electronics 20 and external devices, such as through the communication path 26, for example. The interface 201 can be capable of any manner of electronic, optical, or wireless communication.

The interface 201, in an embodiment, includes a digitizer 202, wherein the sensor signal comprises an analog sensor signal. The digitizer 202 samples and digitizes the analog sensor signal and produces a digital sensor signal. The interface/digitizer can also perform any needed decimation, wherein the digital sensor signal is decimated in order to reduce the amount of signal processing needed and to reduce the processing time.

The processing system 203 conducts operations of the meter electronics 20 and processes flow measurements from the sensor assembly 10. The processing system 203 executes one or more processing routines and thereby processes the flow measurements in order to produce one or more flow characteristics.

The processing system 203 can comprise a general-purpose computer, a micro processing system, a logic circuit, or some other general purpose or customized processing device. The processing system 203 can be distributed among multiple processing devices. The processing system 203 can include any manner of integral or independent electronic storage medium, such as the storage system 204.

In the embodiment shown, the processing system 203 determines the vibration mode frequency characteristics from vibrational responses 220. The processing system 203 can determine at least a magnitude, phase difference, time difference, and a frequency of the responses 220.

The storage system 204 can store flowmeter parameters and data, software routines, constant values, and variable values. In one embodiment, the storage system 204 includes routines that are executed by the processing system 203. In one embodiment, the storage system 204 stores a phase shift routine 212, a notification routine 213, a phase difference routine 215, a frequency routine 216, a time difference (Δt) routine 217, and a strain detection routine 218. In some embodiments, the storage system 204 stores one or more flow characteristics obtained from the flow measurements.

The strain detection routine 218 detects strain from at least one strain gage. A resistance of at least one strain gage is measured, and subsequently compared to a baseline resistance. The baseline resistance is the default strain gage resistance that is typically measured and baselined into the transmitter at the factory under controlled conditions. The strain detection routine 218 indicates a primary containment failure if the strain gage resistance is different from the baseline resistance by a predetermined amount. The predetermined amount will vary depending on at least the strain gage location, the size and geometry of the flowmeter, and the operating conditions. The notification routine 213 may trigger an alarm and/or halt flowmeter operation and/or halt the process if the strain detection routine 218 indicates a primary containment failure.

Bridge circuits may be used in these embodiments for amplifying a strain signal. In other embodiments, however, strain signals are utilized without any bridge circuitry.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other devices and methods, and not just to the embodiments described above and shown in the accompanying figures. Accordingly, the scope of the invention should be determined from the following claims.

What is claimed is:

1. A flowmeter (5) including a sensor assembly (10) and a meter electronics (20), configured to detect a containment failure within a flowmeter case (198), comprising:
one or more flow tubes (130, 130′);
a drive mechanism (180) coupled to the one or more flow tubes (130, 130′) and oriented to induce a drive mode vibration in the one or more flow tubes (130, 130′);
a pair of pickoff sensors (170L, 170R) coupled to the one or more flow tubes (130, 130′), and configured to measure a vibrational response of the flow tubes (130, 130′) induced by the drive mechanism (180);
at least one strain gage (200) inside the case (198) configured to detect a strain;
wherein the meter electronics (20) is connected to the drive mechanism (180) and the at least one strain gage (200), and the drive mechanism (180) and the at least one strain gage (200) are connected in series; and
wherein the meter electronics (20) is configured to measure a resistance of the strain gage (200), and compare the resistance of the strain gage (200) to a baseline resistance, and wherein the meter electronics (20) is configured to indicate the primary containment failure if the resistance of the strain gage (200) is different from the baseline resistance by a predetermined amount.

2. The flowmeter (5) of claim 1, wherein meter electronics (20) is configured to trigger an alarm if the resistance of the strain gage (200) is different from the baseline resistance by a predetermined amount.

3. The flowmeter (5) of claim 1, wherein the at least one strain gage (200) is coupled to a flowmeter case (198).

4. The flowmeter (5) of claim 1, wherein the at least one strain gage (200) is coupled to the one or more flow tubes (130, 130′).

5. The flowmeter (5) of claim 1, wherein the at least one strain gage (200) is coupled to a brace bar (140, 140′).

6. The flowmeter (5) of claim 1, wherein a signal from the one or more strain gages (200) is superimposed onto other signals carried by a drive mechanism series circuit.

7. The flowmeter (5) of claim 1, wherein a drive mechanism series circuit comprises a Wheatstone bridge.

8. A method for detecting a containment failure within a case of a flowmeter having a sensor assembly and meter electronics, comprising the steps of:
vibrating at least one of the one or more flow tubes in a drive mode vibration with a drive mechanism;
measuring a vibrational response of the flow tubes induced by the drive mechanism with a pair of pickoff sensors;
providing at least one strain gage inside the case;
connecting the drive mechanism and the at least one strain gage to the meter electronics, wherein the drive mechanism and the at least one strain gage are connected in series;
measuring a resistance of the strain gage;
comparing the resistance of the strain gage to a baseline resistance; and
indicating containment failure if the resistance of the strain gage is different from the baseline resistance by a predetermined amount.

9. The method of claim 8, comprising the step of triggering an alarm if the resistance of the strain gage is different from the baseline resistance by a predetermined amount.

10. The method of claim 8, comprising the step of coupling the at least one strain gage to the flowmeter case.

11. The method of claim 8, comprising the step of coupling the at least one strain gage to the one or more flow tubes.

12. The method of claim 8, comprising the step of coupling the at least one strain gage to a brace bar.

13. The method of claim 8, comprising the step of superimposing a signal from the one or more strain gages onto other signals carried by a drive mechanism series circuit.

14. The method of claim 8, comprising the step of providing a Wheatstone bridge in a drive mechanism series circuit.
